(19) United States
(12) Patent Application Publication
(10) Pub. No.: US 2025/0010980 A1
(43) Pub. Date: Jan. 9, 2025

(54) AUTONOMOUS ELECTRIC, WEIGHT-SHIFT CONTROL UNMANNED AERIAL VEHICLE

(71) Applicant: Romaeris Corporation, Ottawa (CA)

(72) Inventors: Anthony F. PIZARRO, Ottawa (CA); Bruno C. DOERWALD

(21) Appl. No.: 18/708,501

(22) PCT Filed: Nov. 9, 2022
(86) PCT No.: PCT/CA2022/051654

§ 371 Date: May 8, 2024

Related U.S. Application Data
(60) Provisional application No. 63/277,321, filed on Nov. 9, 2021.

(51) Int. Cl. B64C 17/02; B64C 31/028

(52) U.S. Cl. CPC B64C 17/02; B64C 31/0285

(57) ABSTRACT

There is provided an improved weight-shift control flexible wing aircraft and improved systems and methods for recovering or preventing a spiral dive or a stall of a weight-shift control flexible wing aircraft. The aircraft including a frame; a wing assembly defining a flexible sail extending from port to starboard sides of the vehicle, the flexible wing assembly comprising: a wing keel extending from fore to aft ends of the wing assembly; a pair of wings, wherein each side of said pair of wings has a strut coupled to and extending away from the wing keel and defines a leading edge and a trailing edge when the wing assembly is moved though air, wherein the trailing edge of each side of said pair of wings is configured for actuable reversible billowing in at least a portion along a length of the trialing edge.

### CROSS REFERENCE TO RELATED APPLICATIONS

This application claim priority to U.S. Provisional application No. 63/277,321 filed Nov. 9, 2021 and entitled “Autonomous electric, weight-shift control unmanned aerial vehicle”, the contents of which are incorporated herein by reference in its entirety.

### TECHNICAL FIELD

The present invention relates, in one embodiment, to aircraft and in particular, improved weight-shift control flexible wing aircraft and improved systems and methods for operating weight-shift control flexible wing aircraft.

### BACKGROUND

Unmanned aerial vehicles (UAVs) are expanding in military and civilian applications including surveillance and remote sensing, combat, and cargo delivery. UAVs, depending on their designs, may be inexpensive to manufacture and operate and have the flexibility to perform a wide variety of demanding missions or operations.

A weight-shift control flexible wing aircraft can operate as a UAV without the direct input of a ground operator, having a flight controller that can guide the aircraft autonomously to a predetermined destination. Such a weight-shift control flexible wing UAV would take into account obstacles, the condition and behavior of the aircraft and of environmental circumstances, issue appropriate commands to mechanical, guidance and actuation systems, and accept confirmation of correct movement of actuation systems and of resulting flight path and aircraft behavior.

Known weight-shift control flexible wing aircraft can comprise: a continuous wing assembly extending from port to starboard sides of the aircraft, the wing assembly comprising a wing body which is at least partly flexible whereby aircraft control is effected at least partially by flexing portions of the wing assembly; a fuselage attached to the wing assembly by a wing/fuselage joint structure configured to permit at least two mutually orthogonal axes of rotation of the fuselage relative to the wing structure, a control system for programming flight information and aircraft control instructions; and a plurality of actuators responsive to the control system for rotating the fuselage relative to the wing assembly about said two axes of rotation and flexing the wing assembly for controlling the flight of the aircraft in response to instructions from the control system.

Weight shift control aircraft, under certain speed and banking conditions, can enter spiral dives that may not be recoverable and hence lead to a crash and this can happen, for example, at low airspeeds and at high angle of attack when lift on one side is lost if the wing is rolled too far to that side. In order for a weight-shift control aircraft to recover from a spiral dive it is necessary to pitch the wing downwards sharply to reduce the angle of attack and to increase airspeed. Unfortunately, this is a complex procedure that must executed quickly in a brief window of opportunity to avoid a crash.

Accordingly, there is a need for making various improvements to weight-shift control flexible wing aircraft to improve speed and turn control, improve stability, improve spiral dive recovery with less loss of altitude, increase maneuverability, and increase overall efficiency, especially if the aircraft are unmanned and there is no human pilot on board to make rapid and informed decisions.

It is known that propellers may be designed having various torque, thrust, and RPM characteristics; however, known propeller configurations are not necessarily optimized for performance in different air densities during flight.

Accordingly, there is a need for various improvements in propulsion systems for weight-shift control flexible wing aircraft to increase overall take-off, flight, and landing efficiency and performance.

Weight-shift control flexible wing aircraft are extremely versatile and are useful in a variety of different environmental conditions. In some cases, the aircraft are required to land or take off in varied and difficult terrain. For example, rough terrain, sand, or mud, and in case of short runways, with fast braking and/or fast take off. Accordingly, there is a need for various improvements in weight-shift control flexible wing aircraft design to allow excellent operational versatility in as many different and difficult operating conditions on the ground and in flight.

### SUMMARY OF THE INVENTION

It is an embodiment of the present disclosure relates to a weight-shift control flexible wing aircraft comprising a frame, a wing assembly extending from said frame and said frame moveable in respect to the wing, a propulsion assembly for providing thrust, and a battery electrically connected to the propulsion unit to provide electrical energy for the thrust.

In one aspect, the weight-shift control flexible wing aircraft further comprises accessory supports moveably secured to the frame for supporting accessories comprising cargo, batteries, and electronics. In aspects, the accessory supports allow for internal weight shift of cargo, batteries, and/or electronics, to balance and/or improve rebalancing.

In some embodiments, the weight-shift control flexible wing aircraft further comprises an electric generator and a fuel source for powering the electric generator, said electric generator electrically coupled to the batteries and/or propulsion assembly.

In one aspect, the weight-shift control flexible wing aircraft further comprises a landing assembly comprising wheels for rolling on terrain or floats for landing on water or skis for landing on snow or ice. In one aspect, the wheels are powered for assisting take off and/or improved maneuverability on the ground.

In some embodiments, the present disclosure relates systems and methods of altering wing shape of a weight-shift control flexible wing aircraft to produce a combination of bank and/or yaw to recover weight-shift control flexible wing aircraft from a stall and/or a spiral dive. In some aspects, the systems and methods improve the ability for the aircraft to make flatter turns with less loss of altitude. In some aspects, the systems and methods relate to keel shift, tail shift, and billow shift methods of altering wing shape. In one aspect, the weight-shift control flexible wing aircraft comprises actuable billows that are configured to asymmetrically actuate on either side of the wing to provide a controlled change in direction of flight.

In some embodiments, the propulsion assembly comprises a motor and a propeller driven by the motor. In one aspect, the propulsion assembly is mounted on a front portion of the frame in a tractor configuration or on a rear portion of the frame in a pusher configuration. In one aspect, there is a plurality of propulsion assemblies, a first assembly on the front portion of the frame and a second assembly on rear portion of the frame. In one aspect, the propulsion assembly is mounted to the wing and in front of the leading edge of the wing.

In some embodiments, the propulsion assembly further comprises a shroud to prevent accidental contact with the motor and/or the propeller. In some aspects, the shroud is a ducted fan. In some aspects, the shroud is in a partial circular shape such as a semi-circle or a quarter-circle instead of being completely circular.

In some embodiments, the propellers are coaxial propellers. In aspects, the coaxial propellers comprise two propellers, each one propeller adapted to operate at different speeds and/or each one propeller is adapted for attitude. In some embodiments, the propellers comprise blades moveable between an extended working position and a retracted rest position

According to one embodiment the present invention relates to a weight-shift aerial vehicle comprising:
a frame;
a wing assembly defining a flexible sail extending from port to starboard sides of the vehicle, the flexible wing assembly comprising:
a wing keel extending from fore to aft ends of the wing assembly;
a pair of wings, wherein each side of said pair of wings having has a strut coupled to and extending away from the wing keel and;
wherein each of said pair of wings defines a leading edge and a trailing edge when the wing assembly is moved though air, and wherein the trailing edge of each side one of said pair of wings is configured for actuable reversible billowing in at least a portion along a length of the trialing edge;
a joint pivotally coupling the frame to the wing assembly, the joint configured to permit the frame to rotate in at most two mutually orthogonal axes of rotation relative to the wing assembly, wherein pivotal movement of the frame relative to the wing assembly shifts the center of mass of the frame beneath the wing assembly; and
a propulsion unit for providing thrust coupled to the frame, the wing assembly, or both the frame and the wing assembly.

In one aspect, the actuable reversible billowing alters the shape of the flexible sail to result in a change in direction of flight. In one aspect, the actuable reversible billowing in at least a portion along a length of the trialing edge of a first side of said pair of wings is effected by actuable movement that brings the wing keel a distance towards an intersection of the leading edge with the strut of the first side of said pair of wings; the actuable reversible billowing in at least a portion along a length of the trialing edge of a first side of said pair of wings is effected by actuable movement that brings the at least a portion along a length of the trialing edge a distance towards an intersection of the leading edge with the strut of the first side of said pair of wings; or the actuable reversible billowing in at least a portion along a length of the trialing edge of a first side of said pair of wings is effected by actuable movement that brings the wing keel a distance towards at least a portion along a length of the trialing edge while leaving unaltered the distance between the wing keel and an intersection of the leading edge with the strut of the first side of said pair of wings.

In one aspect, actuation of the actuable reversible billowing on one side of said pair of wings is independent from or is simultaneous with actuation of the actuable reversible billowing in the other side of said pair of wings.

In one aspect, said trailing edge extends aft of an intersection of the wing keel and the trailing edge.

In one aspect, the frame comprises a downwardly extending mast that pivotally couples the frame to the joint and a support coupled to and extending away from the mast.

In one aspect, the support is adapted to carry the propulsion unit, cargo and/or sensor equipment ahead of the mast.

In one aspect, the cargo and/or sensor equipment is moveably supported such that displacement of the cargo and/or sensor equipment permit fine tuning of the overall balance and center of mass of the aerial vehicle.

In one aspect, the propulsion unit comprises one or more propellers. In one aspect, the propulsion unit comprises a pair of propellers arranged in side-by-side arrangement. In one aspect, the propulsion unit comprises a pair of propellers arranged along a common longitudinal axis. In one aspect, the pair of propellers is configured so that one of the pair of propellers has one or more of contrasting aerodynamic and performance optimization and operation at different speeds of rotation relative to the other of the pair of propellers. In one aspect, the one or more propellers comprise blades moveable between an extended working position and a retracted rest position. In one aspect, the propulsion unit comprises one or more propellers emplaced forward of the wing.

In one aspect, the aerial vehicle further comprising a shroud to cover the one or more propellers to prevent unintentional contact.

In one aspect, the aerial vehicle further comprising a petrol motor and/or an electric motor for driving the propulsion unit. In one aspect, the aerial vehicle further comprising and a battery for powering the electric motor and a generator for powering the battery and/or a fuel tank for powering the generator or the petrol motor.

In one aspect, the aerial vehicle further comprising a landing gear assembly extending downwards from the wing keel, the landing gear assembly comprising a pair of down tubes connected to each other at one end and a control bar having ends for connecting another end of each one of the pair of down tubes, and a pair of wheel for rolling on terrain or a pair of floats or skis. In one aspect, the pair of wheels are powered for assisting takeoff and/or for providing maneuverability on the ground.

In one aspect, the flexible wing assembly further comprises vertical winglets at the port and starboard ends.

In one aspect, the two mutually orthogonal axes of rotation is a first horizontal axis for permitting roll of the frame relative to the wing and a second horizontal axis orthogonal to the first axis for adjusting pitch of the frame relative to the wing assembly.

According to one embodiment the present invention relates to a method for recovering or preventing a spiral dive or a stall of a weight-shift aerial vehicle during flight, the vehicle having a frame; a wing assembly defining a flexible sail that extends from port to starboard sides of the vehicle; a joint permitting for pivotal movement of the frame relative to the wing assembly to shift the center of mass of the frame beneath the wing assembly; the flexible wing assembly comprising: a wing keel extending from fore to aft ends of the wing assembly; a pair of wings, wherein each side of said pair of wings having has a strut coupled to and extending away from the wing keel and; wherein each of said pair of wings defines a leading edge and a trailing edge when the wing assembly is moved though air; wherein the trailing edge of each side one of said pair of wings is configured for actuable reversible billowing in at least a portion along a length of the trialing edge; a joint permitting for pivotal movement of the frame relative to the wing assembly to shift the center of mass of the frame beneath the wing assembly; and a propulsion unit for providing thrust coupled to the frame, the wing assembly, or both the frame and the wing assembly, the method comprising the steps of:
identifying a pre-condition leading to a stall or a spiral dive during flight; and
altering the shape of the flexible sail by reversibly actuating billowing in at least a portion along a length of the trialing edge in one side of said pair of wings or both sides of said pair of wings.

In one aspect, the reversibly actuating billowing comprises:
decreasing a distance between the wing keel and an intersection of the leading edge with the strut of a first side of said pair of wings;
decreasing a distance between at least a portion along a length of the trialing edge and an intersection of the leading edge with the strut of a first side of said pair of wings;
decreasing a distance between the wing keel and at least a portion along a length of the trialing edge while leaving unaltered the distance between the wing keel and an intersection of the leading edge with the strut of a first side of said pair of wings; or
a combination thereof;
and thereby recovering or preventing the spiral dive or the stall of the weight-shift aerial vehicle.

In one aspect, the reversibly actuating billowing on one side of said pair or wings is independent of or is simultaneous with an actuation of the actuable reversible billowing in the other side of said pair of wings. In one aspect, the pre-condition leading to a stall or a spiral dive during flight comprises one or more of air speed, roll, angle of attack, absolute position of the wing assembly with respect to the earth and the relative position of the fuselage with respect to the wing assembly.

Directional references herein, such as “vertical”, “horizontal” and the like are used purely for convenience of description and are not intended to limit the scope of the invention, as it will be evident that the components described herein may be oriented in any direction.

Furthermore, specific dimensions, materials, fabrication methods and the like are presented here merely by way of an example and are not intended to limit the scope of the invention.

### BRIEF DESCRIPTION OF THE DRAWINGS

FIG. 1 is a side elevation view of one embodiment of a weight-shift control flexible wing aircraft with fuselage frame assembly and landing gear assembly in accordance with an embodiment of the present invention;

FIG. 2 is a rear perspective view of a weight-shift control flexible wing aircraft in accordance with an embodiment of the present invention;

FIG. 3 is a perspective view of the fuselage frame assembly a weight-shift control flexible wing aircraft in accordance with an embodiment of the present invention; FIG. 3A is an enlarged illustration of the joints connecting to mast to the rear strut; FIG. 3B is an enlarged illustration of the joints connecting the mast to the rear strut comprising rod ends; FIG. 3C is an enlarged illustration of the joint and load reinforcement plate to reinforce load bearing capability;

FIG. 4 is a perspective view of a moveably adjustable cargo pod of the weight-shift control flexible wing aircraft in accordance with an embodiment of the present invention;

FIG. 5 is a bottom view of the moveably adjustable cargo pod;

FIG. 6 is a front elevation view of the landing gear assembly;

FIG. 7 is a front elevation view of the front landing gear assembly;

FIG. 8 is a rear perspective view of the weight-shift control flexible wing aircraft showing a keel shift operation in accordance with an embodiment of the invention;

FIG. 9 is a rear perspective view of the aircraft showing a sail shift operation in accordance with an embodiment of the invention;

FIG. 10 is a rear perspective view of the aircraft showing a billow shift operation in accordance with an embodiment of the invention;

FIG. 11 is a top view of the wing of the aircraft showing an tractor-type arrangement of the propeller in accordance with an embodiment of the invention, where the abbreviation LE means “leading edge”;

FIG. 12 is a side perspective view of a co-axial propeller for use in the weight-shift control flexible wing aircraft in accordance with an embodiment of the invention;

FIG. 13 is a side perspective view of a foldable propeller for use in the weight-shift control flexible wing aircraft in accordance with an embodiment of the invention;

FIG. 14 is a side perspective view of one embodiment of a weight-shift control flexible wing aircraft in flight in accordance with an embodiment of the invention; and

FIG. 15 is a flowchart of a system and a method for recovering or preventing a spiral dive or a stall of a weight-shift aerial vehicle during flight.

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts.

“Flex-Wing Aircraft” means: an aircraft having a wing that changes shape in response to certain flight conditions in ways that affect the aerodynamic control of the aircraft.

“Weight shift control” means: a) an aircraft that can be maneuvered by shifting the aircraft's center of mass left to right and vice-versa relative to the wing of the aircraft, which in turn causes the wing to deform flexibly and the lift characteristics of the port and starboard sides of the wing to change with respect to each other, thus maneuvering the aircraft; b) an aircraft that can be maneuvered by shifting the aircraft's center of mass front to rear and vice-versa relative to the wing of the aircraft, which in turn causes the aircraft to pitch upward or downward, thus maneuvering the aircraft; and c) any combination of a) and b).

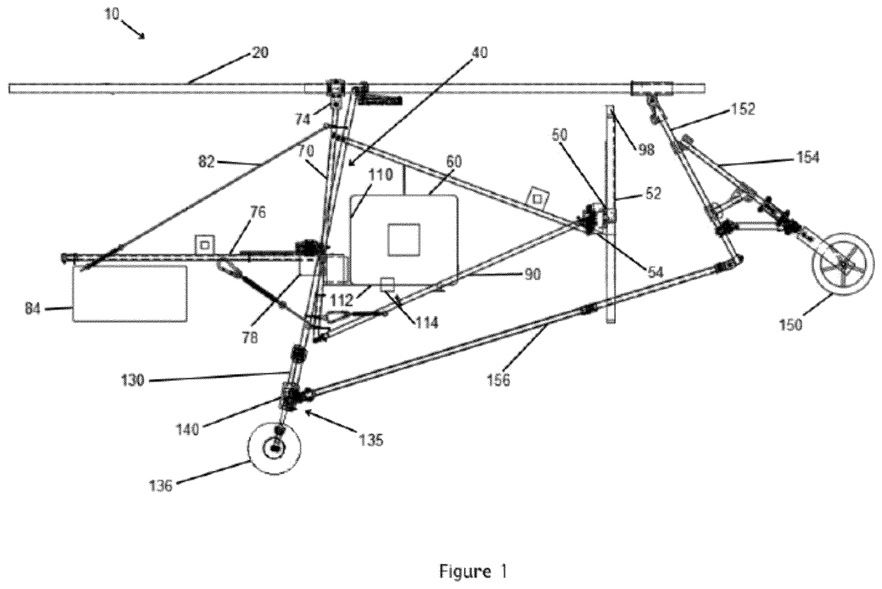

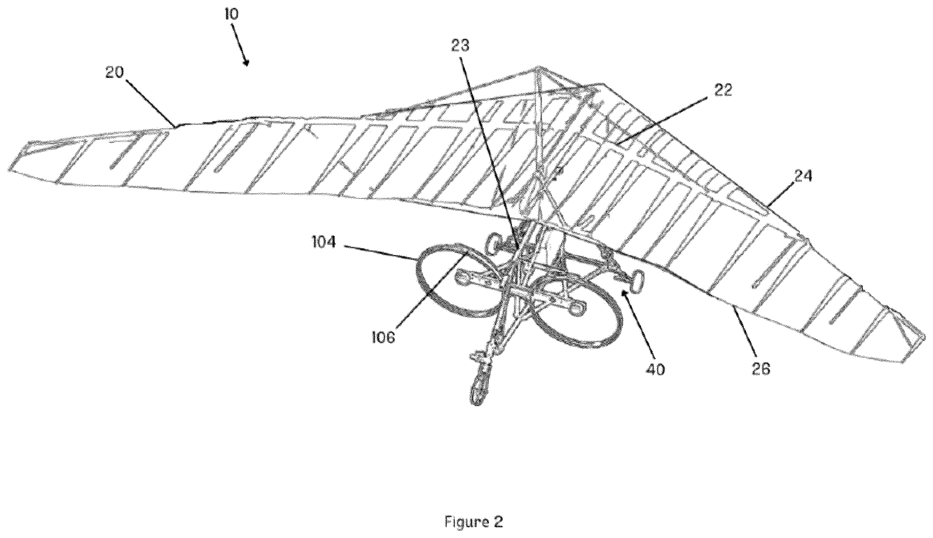

FIGS. 1 and 2 depict a weight-shift control flexible wing aircraft 10. Aircraft 10 includes a wing assembly 20 comprising a port-side wing and starboard-side wing, a main strut 22 comprising a port-side strut and a starboard-side strut, a wing keel 23 (also called a wing center tube) extending from fore to aft ends of the wing assembly 20, a leading edge 24 and trailing edge 26 defined by the wing assembly 20, a fuselage frame 30, and a landing assembly 40. Fuselage frame 30 and landing assembly 40 extend downward from the wing assembly 20. As will be discussed in further detail below, fuselage frame 30 is pivotally moveable is respect to the wing assembly 20. Aircraft 10 includes a propulsion assembly 50 for providing thrust including a propeller 52 driven by a motor 54, and one or more batteries 60 electrically connected to the motor 54 of the propulsion unit to provide electrical energy for the thrust.

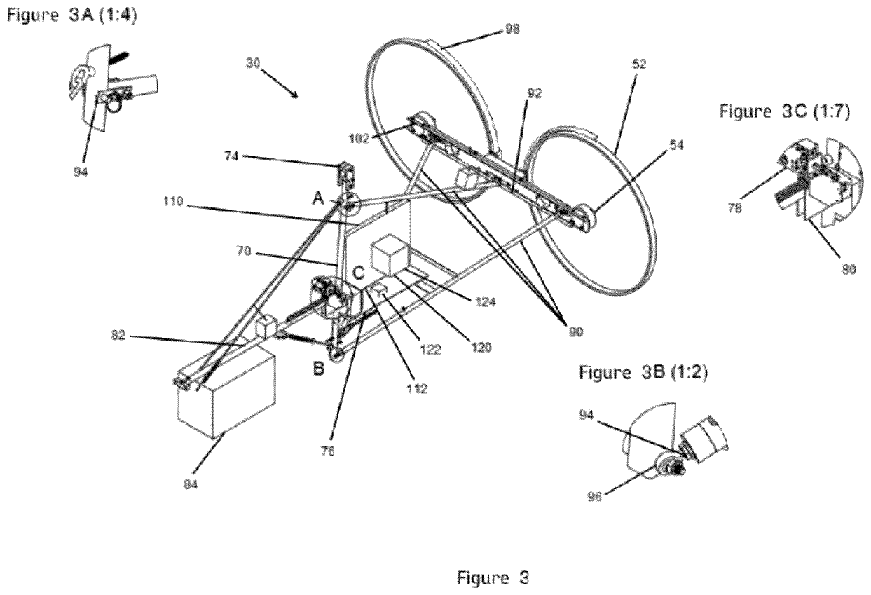

As depicted in FIGS. 1 and 3, frame 30 comprises a vertical mast 70 affixed to the wing keel 23 with a hang block 74 that is a joint permitting two degrees of freedom of movement. The vertical mast 70 can be substantially vertical and supports a nose strut 76 in the forward direction that is joined to the mast 70, typically at a right angle, by a mechanical joint 78 that may include plate(s) 80 to reinforce load bearing capability. The nose strut 76 may also be supported by guy wire(s) 82 to the mast 70.

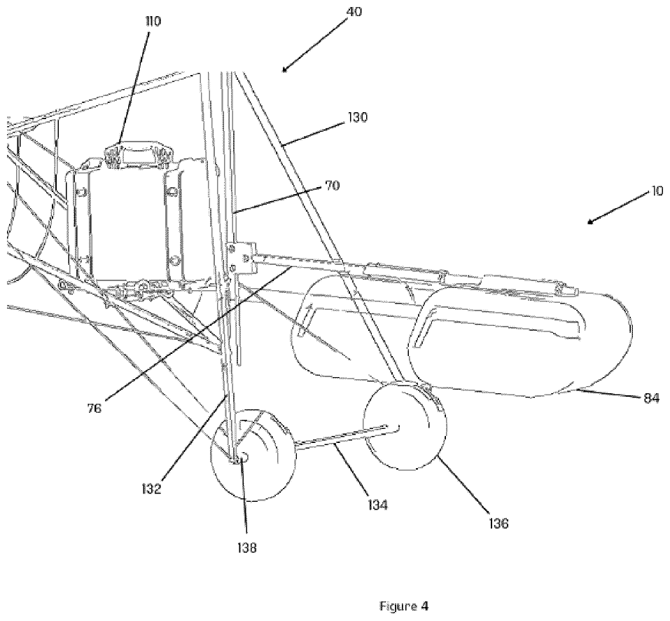

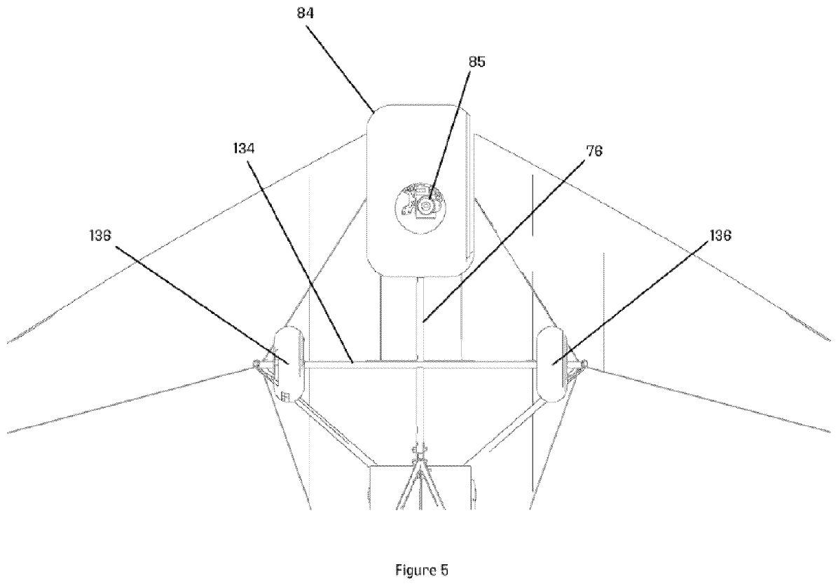

As depicted in FIGS. 1 to 5, a cargo box or pod 84 is supported by the nose strut 76 and may be used to carry various types of cargo and/or sensor equipment such as cameras and gimbals (not shown). As shown in the FIG. 5, the box or pod 84 is configured for placement that provides a clear line of sight downward from the pod 84 such that field of view is wide and clear as may be needed when mounted with sensor equipment. Beneficially, the placement of the cargo box or pod 84 allows for adaptions needed for forward or backward movement on the nose strut 76. Displacement of the cargo box by sliding movement, for example, allows for fine tuning of the overall balance and center of gravity of the aircraft 10 and allows for increases in flight efficiency, for example, by improving the trim of the aircraft which leads to improved aerodynamics. In some aspects, increased flight is achieved by improved balancing of the fuselage and the wing for the most efficient flight for a given speed and load. On the other hand, if the aircraft 10 is not properly trimmed, the actuators will have to force straight and level flight, hence flying less efficiently and/or use of increased energy to operate the actuators out of trim.

As depicted in FIG. 3, one or more rear struts 90 extend rearward from the mast 70 to join a cross piece 92. One or more joints 94 connect the mast 70 to the rear struts 90 and may comprise tie rod ends 96 so that the angles of the joint 94 are adjustable and can be field assembled easily.

In greater detail, the propulsion assembly 50 is supported by the cross piece 92. Shrouds 98 built of aluminum tubing or other suitable material may be attached to the motor cross piece. Shrouds 98, if they reach the bottom of the aircraft, shield the propellers from accidental impact with the ground when the aircraft taxis over rough terrain, or under other circumstances. In one embodiment, the propeller shrouds 98 also serve to protect the propellers 52 from accidental contact with the rear section of the wing keel 23 (also known as a “stinger”) in the pitch-up position (wing nose up and trailing edges downward). As shown, the rearmost portion of the wing keel tube 23 that protrudes behind the wing assembly 20 can be adapted to fall between the two propellers 52. Propeller shrouds 98 can also take the form of ducted fans to improve airflow efficiency and reduce emitted noise during operations, especially in noise sensitive areas. Propeller shrouds 98 can also take a semi-circular or a quarter-circle shape instead of being fully circular.

In greater detail, batteries 60 for powering the electric motors are encased in a battery case 110 that is supported by a battery tray 112 secured behind the mast 70. Alternatively, batteries 60 may emplaced in front of the mast 70. Batteries 60 may be ganged together in a single case 110 or in multiple cases 110 that sit on top of the tray 112 and are fastened to it by strap 114 or by other means and are easily removeable and replaceable in the event that new or different batteries need to be used. The battery tray 112 may be expanded in size to accommodate additional batteries 60 if greater aircraft range or endurance is required or depending upon cost considerations.

An electrical generator 120 and a fuel tank 122 for the generator motor 54 is secured by a bracket 124 below the tray 112. When provided, the generator 120 and fuel tank 122 will provide additional range and endurance by feeding the motors and recharging the batteries 60 during flight. In some embodiments (not shown), generator 120 and fuel tank 122 are secured the below the mast 70.

In the present embodiment, the entire fuselage frame 30 including the mast 70, front struts 76 and rear struts 90, batteries 60, generator 120, propellers 52 and motors 54 shifts position as an assembly under the wing; fore and aft directions and left and right directions. Movement may be effected by means of various actuators (e.g. winch (rotary)) as disclosed in PCT Patent Application No. PCT/CA2018/050657 and published as WO 2019/218370, which is incorporated by reference in its entirety. As will be appreciated, the shifting of position affects the center of mass of the aircraft 10 and this causes the aircraft 10 to maneuver in flight.

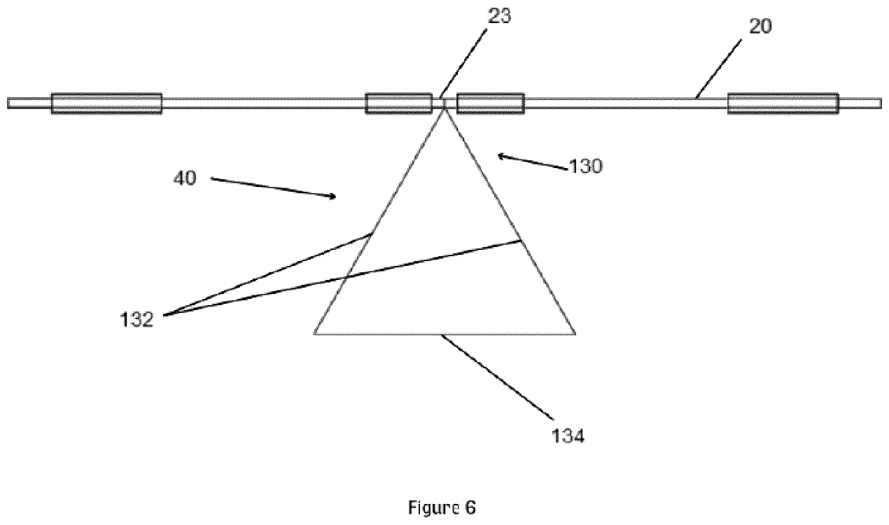

In greater detail, as shown in FIG. 6, landing gear assembly 40 extends downward from the wing keel 23 in FIG. 1. Landing gear assembly 40 comprises a forward member 130 that has a generally triangular comprising two downwardly extending down tubes 132 secured at one end to the wing keel 23 and at the other secured to a horizontal control bar 134.

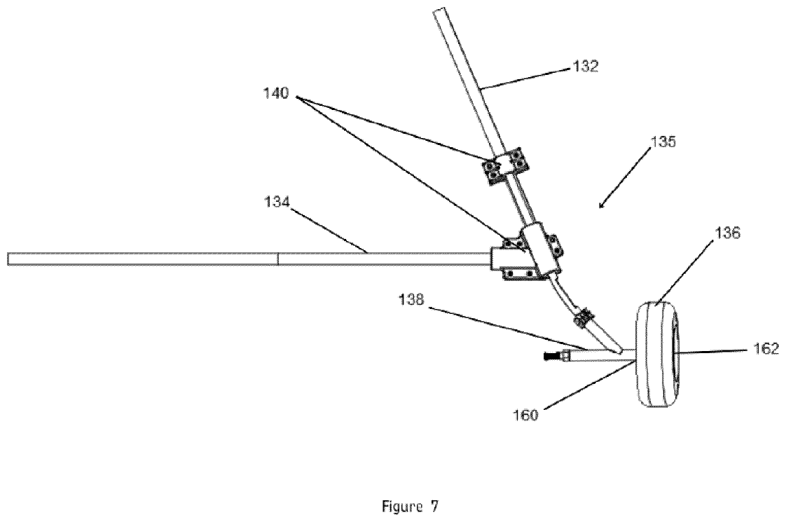

With reference to FIG. 7, a front landing gear assembly comprises two wheels 136 and an axle 138 and is secured to the forward members 134 and 132 at the bottom. The axle 138 and wheel 136 may be attached using brackets 140 on the horizontal control bar 134 and downtube 132 given that the tube rising upward from the wheel 136 and axle 138 passes directly into and is clamped by these brackets 140. In this manner the wheels 136 of the forward member can easily be detached and replaced by different types of wheels for use in different terrain. For example, pneumatic tires or larger sized tires depending on how rough or uneven the ground may be at various take-off and landing sites. Similarly, tires with greater or lesser treads may be used. Alternatively, the wheels 136 can be attached directly to the horizontal bar 134 with no need for a parallel axle below. Use of the brackets 140 allows a number of adjustments to be made to the landing gear and aircraft very easily to improve taxi and flight characteristics should the need arise. The brackets 140 are clamped with bolts to the downtube 132 and horizontal bar 134, and these bolts can be loosened so that the orientation of the wheel with respect to the aircraft can be changed; for example, the axle 138 and the adjoining rod that extends upward into the bracket can be pivoted so the wheel toe angle can be adjusted for toe-in or toe-out orientation, to varying degrees. This is known to make an aircraft taxi in a straighter line with no steering inputs. This rod can also be pushed upward or downward when the brackets are loosened, and given the curved shape of the rod, this may adjust the camber of the wheel, also affecting steering characteristics. Furthermore, by adjusting the rod in this manner, the angle of attack of the wing can be increased or decreased, which will adjust the take-off speed of the aircraft and ground handling characteristics.

Turning back to FIG. 1, a tail wheel 150 may be attached to the rear portion of the wing keel 23 via a rear wheel downtube 152 and a rear wheel strut 154. In one embodiment, tail wheel supports 156 may be used to join the front wheel assembly 130 to the rear wheel downtube 152 and/or the rear wheel strut 154 or wire cables in tension for rigidity (not shown), if required. In combination, the landing assembly 40 comprises three wheels in a tricycle arrangement. The rear wheel 150 may be fitted with a linear or rotary actuator 155 to rotate the wheel and effect ground steering of the aircraft.

In one embodiment, the tail wheel strut 154, the tail wheel actuator 155 may be removed in order to attach the rear wheel 150 directly to the keel 23 via tail wheel strut 152.

In one embodiment, the three wheels as described above may be replaced by floats (not shown) so that the aircraft 10 can take off from and alight on water surfaces such as ponds, lakes and rivers for excellent operational versatility. Optionally, the rear float may be equipped with a flat vertical rudder underneath and the entire float may pivot using the same or similar type of actuation system that would be used with the rear wheel to effect steering.

In one embodiment, the three wheels as described above may be replaced by skis (not shown) so that the aircraft 10 can take off from and alight on ice or snow for additional operational versatility.

In one embodiment, as depicted in FIG. 7, the front landing assembly 130 may include two wheels 136 equipped with electric motors 160 in hub 162 and coordinated electronic speed controllers (not shown). In aspects, this will allow the aircraft 10 to accelerate more quickly especially in rough terrain, sand, or mud and provide smooth and fast braking in case of short runways. In some other aspects, the aircraft 10 can taxi close to people on the ground without propeller thrust, for greater safety and reduction of noise and blowing dust. It also provides an independent means of ground steering the aircraft 10 during take-off and landing, with or without the rear wheel 150 actuated steering, as the rear wheel 150 for example may depart the ground before the front wheels 136. While large or electrically powered front wheels 136 may cause the aircraft 10 to be heavier than normal near the front, this potential problem is addressed by the present invention by being able to conveniently displace batteries 60 or other items carried by the frame 30 further rearward for optimum balance.

In one embodiment, a bent road may be attached to each downtube 132 and the main wheels 136 may be attached to that bent rod to provide a suspension with shock absorption. In another embodiment, the main wheels 136 may be directly attached to the downtube 132 or control bar 134 using a spring suspension mechanism in order to provide a suspension with shock absorption.

In another embodiment, the tail wheel 150 attached to the rear portion of the wing keel 23 and related tail wheel supports 156 joining the front wheel assembly 130 to the rear wheel 150 may be removed. Instead, a single larger (main) wheel is attached to the bottom area of the vertical mast 70 with some shock absorption mechanism, possibly including a rearward bent arm at the lower end where the wheel is held in place. The two front wheels remain attached to the horizontal control bar but can be reduced in size and weight as the main large wheel fulfils the function of carrying the whole aircraft weight on the ground (fuselage frame and wing) and the other two wheels merely serve to balance it. The rear wheel 150 and some lighter weight version of struts 152 and 154 may remain in place for pitch balance, if deemed preferable by the UAV operator. In this embodiment, both the fuselage frame 30 and the wing/control bar 134 assembly touch the ground through the wheels. This single main wheel can be electrically powered or unpowered. Effective steering on the ground may be accomplished by rolling the fuselage with the same roll actuators as used in flight, which has the effect of changing the center of mass of the fuselage 30 slung beneath the wing assembly 20 and causes the aircraft 10 to change directions while taxiing. In other words, when the fuselage is rolled with respect to the front wheels, it scribes an off-center circle causing a very effective turn without need for other turning mechanisms.

The present disclosure also relates to a weight-shift control flexible wing aircraft having improved systems and methods for stall and spiral dive recovery of weight-shift control aircraft. In particular, currently known weight shift control aircraft, under certain speed and banking conditions such as at low airspeeds and at high angle of attack when lift on one side is lost if the wing is rolled too far to that side, the aircraft can enter spiral dives that may not be recoverable and hence lead to a crash. Since known weight-shift control aircraft will depend only on shift of the center of mass beneath the wing, in order for known weight-shift control aircraft to recover from a spiral dive, the wing must first be pitched downwards to reduce the angle of attack and increase airspeed. Unfortunately, these maneuvers are part of a complex procedure that must executed quickly in a brief window of opportunity. Therefore, there is a need to collect the flight condition information to enable quick identification of a pre-condition(s) for leading to a stall or spiral dive during flight and to quickly execute steps during the brief window of opportunity to prevent and/or recover from a stall or a spiral dive of weight-shift control aircraft.

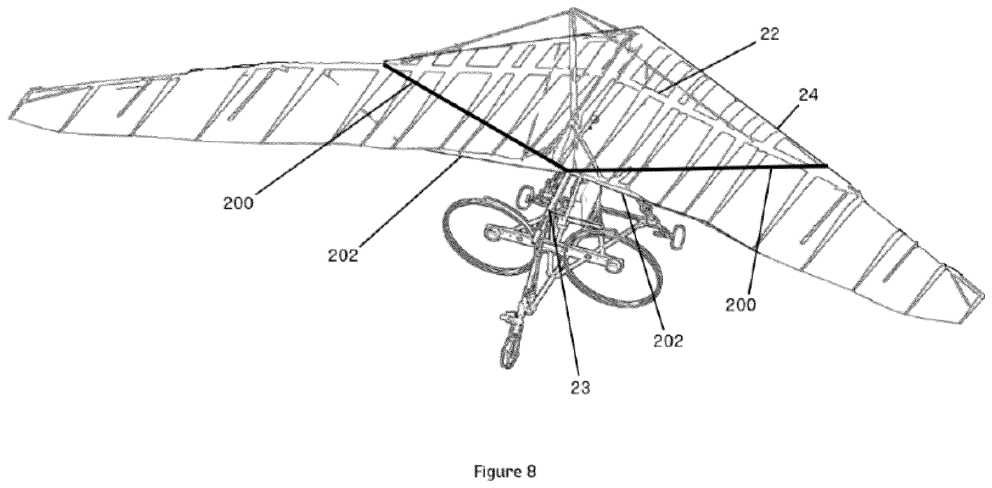

With reference to FIGS. 8 to 10, the present disclosure provides improved systems and methods for altering the wing sail shape of weight-shift control aircraft to assist in spiral dive recovery when the pre-conditions of a stall and a spiral dive are identified during flight. In some embodiments, the systems and methods comprise weight-shift control flexible wing aircraft having independently and reversibly actuable billows that are configured to asymmetrically actuate on either side of the wing to provide a controlled change in direction of flight.

As shown in FIG. 8, one example of a method of altering the wing sail shape of weight-shift control aircraft to assist in spiral dive recovery is to use a keel shift system and method whereby a cable 200 is used to flex and pull the rear section of the wing keel 23 towards the main strut 22 of the wing where it joins the leading edge 24. This creates an additional billow 202 on one side of the wing by shifting the keel 23 away from the center of the wing 20 and produces an asymmetrical nose angle. The result is a flatter, more coordinated turn.

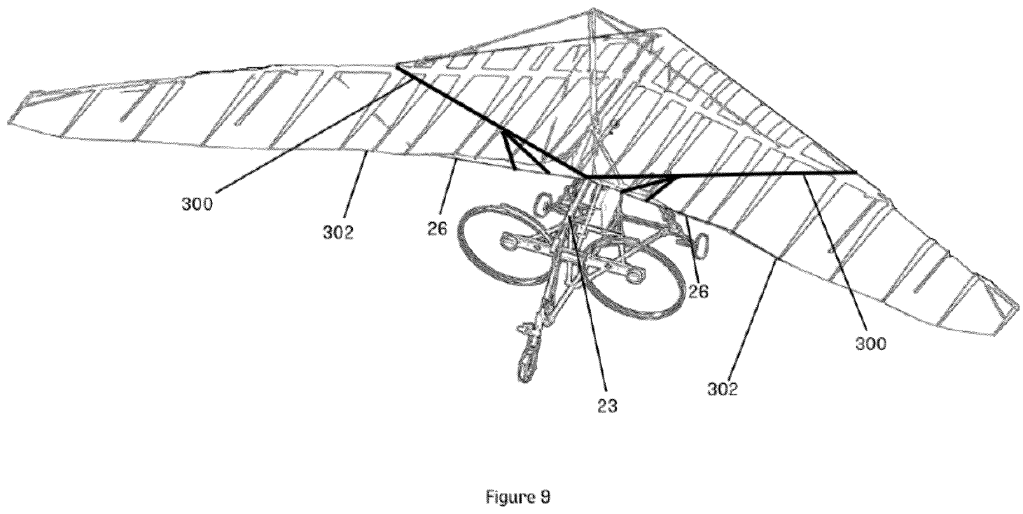

As shown in FIG. 9, another example of a method of altering the wing sail shape of weight-shift control aircraft to assist in spiral dive recovery is to use a sail shift method and system. In the sail shift method and system, a cable 300 is directly connected to the sail material of the wing at the trailing edge 26 and pulls it towards the leading edge 24 of the wing 20 with the result that the aircraft 10 banks and yaws towards the wing side with the greater billow. The sail shift method and system requires little pull force and produces a billow 302 on one side of the wing 20, but does not alter the nose angle.

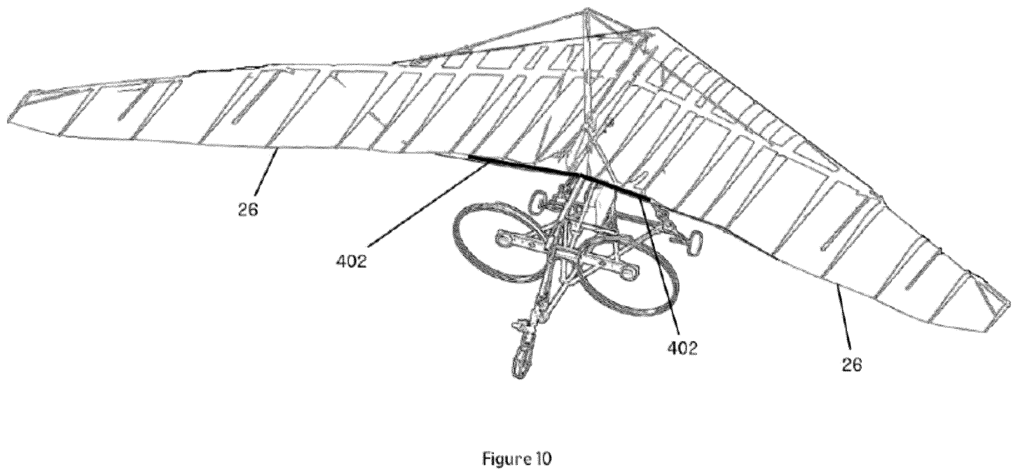

As shown in FIG. 10, another example altering the wing sail shape of weight-shift control aircraft to assist in spiral dive recovery is to use a billow shift method and system. In the billow shift method, a billow 402 is made to shift from one side directly to the other by pulling the trailing edge 26 with respect to the back of the keel 23 and this produces a banked turn with practically no change in nose angle hence minimal yaw effect. In the billow shift method, the fabric is more directly pulls towards the wing keel (i.e. there is no connection to the forward section structural tubes 22) to create billow 402. In contrast, the keel shift pulls directly on the wing structural tubes 22 (i.e. there is a connection to the forward section structural tubes 22 as shown in FIG. 8) to bring them closer together and shorten the distance that the fabric has to cover, creating billow 202.

The three systems and methods disclosed will alter the wing sail shape and is a much simpler and safer option because they produce a combination of bank and/or yaw that may assist the aircraft to recover from a stall in a steeply banked turn more quickly, i.e., with less loss of altitude and hence reduced likelihood of a crash. This is unlike known weight shift control whereby in order to recover from a spiral dive, the wing must first be pitched downwards to reduce the angle of attack and increase airspeed. In particular, all three methods are similar in end effect but different in how the forces are applied to change the billow. In one aspect, keel shift is the most indirect and requires the highest actuator force and is advantageous when you have a large keel pocket. Sail shift requires less force and billow shift requires the least amount of force.

Moreover, the three systems and methods, especially the billow shift, improve the ability to make flatter turns with gentle bank angles. This is advantageous to achieving flight patterns such as those required in commercial UAV missions where for example, the aircraft needs to circle a location on the ground for surveillance purposes and maintain the level orientation of the sensor equipment (e.g., camera) pointed in the intended downward direction as consistently as possible.

Finally, the three systems and methods provide fully redundant roll control in the event of a failure of other actuators on board the weight-shift control flexible wing aircraft, increasing the probability of completion of the mission instead of a potential accident in case of primary control failure.

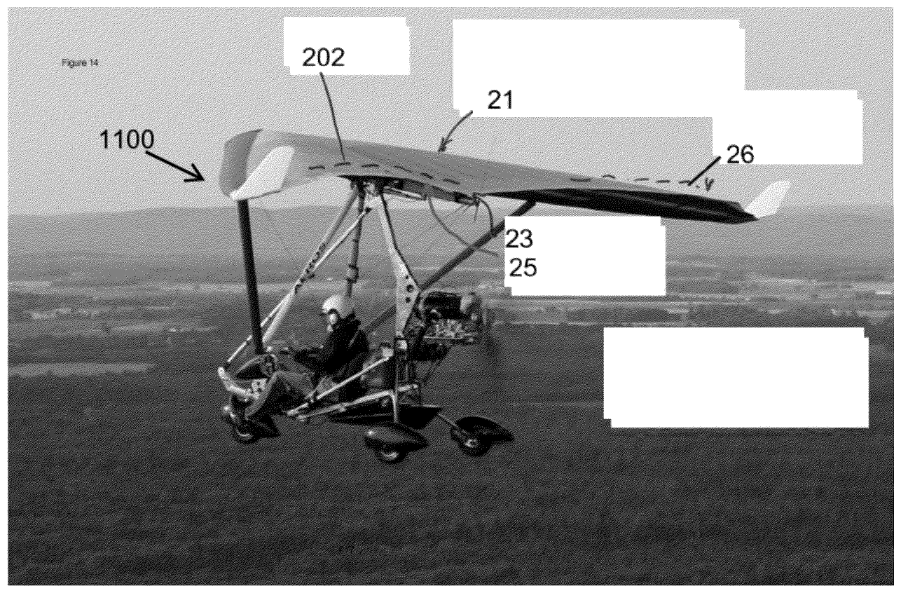

FIG. 14 depicts, according to another embodiment, a manned weight-shift control aircraft aircraft 1100 in level flight in order to illustrate exemplary features of the present invention. In this embodiment, aircraft 1100 is adapted to seat a person that manually operates flight of the aircraft 1100. Aircraft 1100 includes wing 20 having billow 202, and showing the trailing edge 26, top surface 21 of the wing 20, the keel 23, a keel pocket 25 which can provide yaw stability and is adapted to secure the sail to the wing keel with some flexibility to allow the billow to shift, wing tips 27 at the port and starboard ends of the wing 20

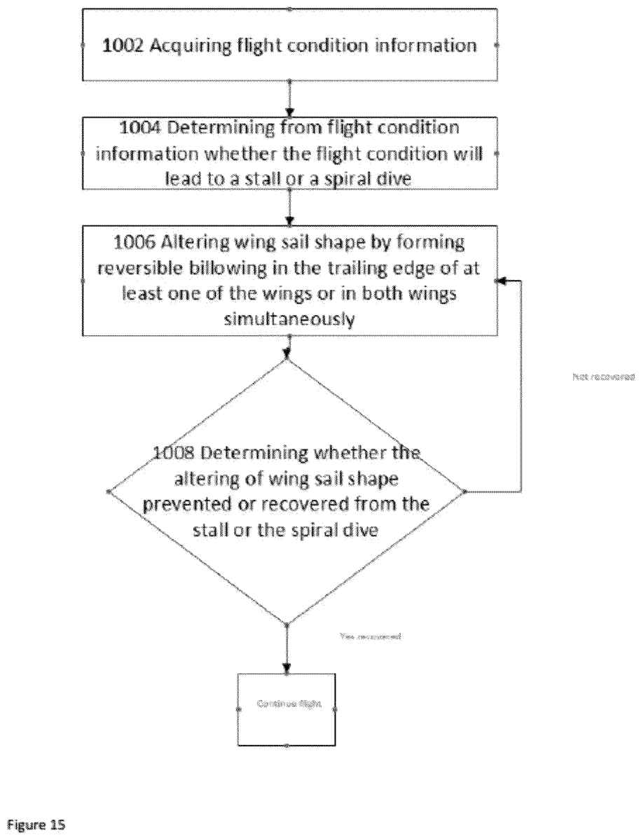

FIG. 15 illustrates a system and a method 1000 for stall and spiral dive prevention and/or recovery of weight-shift control aircraft 10 according to an embodiment of the present invention. At step 1002, flight condition information is collected during flight. Flight condition information includes air speed and banking conditions and/or angle of attack, absolute position of the wing assembly with respect to the earth or the relative position of the fuselage with respect to the wing assembly. At step 1004, a determination is made using the flight condition information whether the condition will lead to a stall or a spiral dive. At step 1006, if the condition will lead to a stall or a spiral dive then the wing sail shape is altered by forming reversible billowing in the trailing edge of one side of the pair of wings independent from the other side or in both sides of the wing assembly simultaneously to result in a combination of bank and/or yaw maneuvers. At step 1008, a determination is made from new flight condition information whether the alteration enabled to aircraft to prevent and/or recover from the stall or the spiral dive.

The description above relates generally to a weight-shift control flexible wing aircraft in a pusher configuration which is one where the propulsion unit is in behind the mast 70. In another embodiment of the present invention, there is provided a first type of tractor configuration where a tail strut is adapted to extend behind the mast 70 and is configured to support various types of cargo and/or sensor equipment such as cameras and gimbals (not shown). A propulsion strut 402 extends forward of the mast 70 and supports a propulsion unit 100 comprising one or more propellers 102 and electric motors 104.

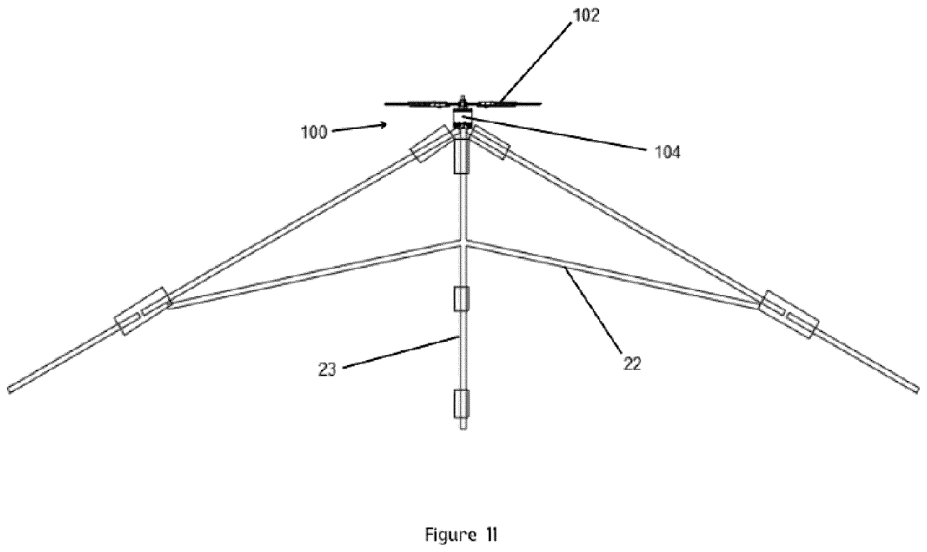

In a further embodiment of the present invention, as depicted in FIG. 11, there is provided a second type of tractor configuration where the propulsion unit 100 with propeller 102 and motor 104 mounted to the solid tube frame 23 of the wing 20 at the nose (forward most position of the wing). In this embodiment of a tractor configuration, the electrical power to the motor 104 secured to the wing 20 is by electric connection to batteries 60 secured to the aircraft fuselage frame 30 or the frame of the wing 20. This second type of tractor configuration has advantages, for example, when very short take off roll is desirable. In this case, with extreme wing pitch up position, the front propeller 104 will pull the aircraft 10 immediately at an upward angle. Air sucked into the rear propellers 52 will flow over the top rear of the wing which, when placed at that angle, creates lift that is also aided by the flow of air just under the trailing edge of the wing sucked in by the bottom portion of the rear propellers 52. A burst of power on all motors creates a sharp upward momentum causing the aircraft to lift off the ground and into aerodynamic “ground effect” (cushion of air just above the ground as the aircraft moves forward) where it can accelerate to climb-out speeds very efficiently with no ground roll friction.

In some embodiments the aircraft 10 may have propellers emplaced at locations at both the front and the rear of the mast 70 to form a combined tractor and pusher configuration.

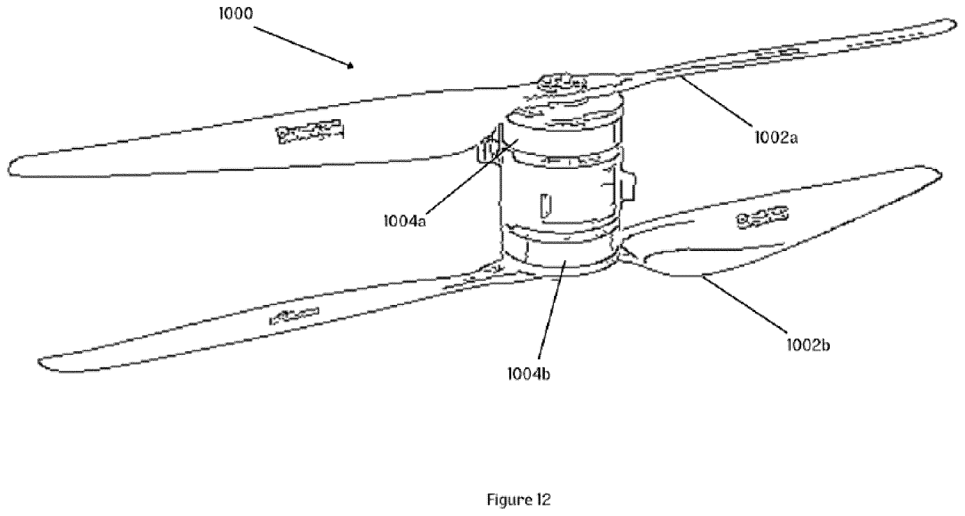

In another embodiment, the aircraft 10 may include a coaxial propulsion unit 1000 comprising two propellers 1002a and 1002b and two motors 1004a and 1004b where the propellers 1002a and 1002b are aligned along a longitudinal axis as shown in FIG. 12. Unlike known coaxial propellers which are typically used for overcoming space limitations that prevent installation of larger diameter propellers, the coaxial propulsion unit 1000 of the present invention comprises a coaxial arrangement of two propellers 1002a and 1002b configured with one or more of contrasting aerodynamic and performance optimization and operation at different speeds.

In one aspect, each one propeller is optimized for either low or high altitude (dense or thin air, respectively) and the provision of electronic speed controllers (not shown) will apply primary thrust to the appropriate motor on the shaft during low altitude flight while the other motor is set to low thrust (coast) power setting with minimal drag but not adding much or any thrust. Upon achieving high altitude flight, the controllers can reverse the settings and apply primary thrust to the other motor and propeller combination, while reducing power to the first propeller. In some aspects, the presently disclosed dual propellers with different pitch and velocity do not have to compromise between existing propellers that are normally adjusted for either better climb-out or better cruise performance. As well, presently disclosed dual propellers have a cost advantage over existing in-flight adjustable propellers. In this manner the aircraft can achieve high altitude flight where aerodynamic drag is low while using the least possible amount of battery power, extending the range and endurance of the aircraft.

In another aspect, there can be performance optimization using with the coaxial propulsion unit 1000 of the present invention because single propeller torque reaction can cause an undesirable weight shift that must be compensated with: either constant roll actuator application or aerodynamic forces such: as roll trim tabs typically located on the wheel pants or displacement of the thrust line either in angle with respect to line of flight or lateral displacement; or by fixed mass displacement.

In another aspect, there can be performance optimization using the coaxial propulsion unit 1000 of the present invention to provide a yaw moment that greatly enhances maneuverability.

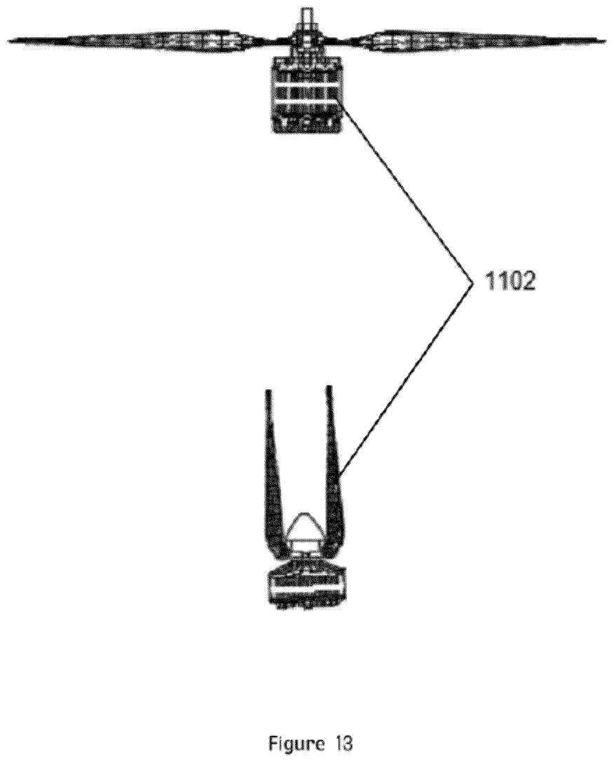

In another embodiment, the aircraft 10 may include at least one set of foldable propellers 1102 as shown in FIG. 13. In such an embodiment, the aircraft 10 may have both front and rear propellers to form a combined tractor and pusher configuration and forward and rear propellers can be propellers 52 and 102 or propellers 1102 that can be folded during flight by means of a mechanical actuator, for example operating within the hub of the propeller or alternatively, by self-feathering when the driven speed decreases. When folded, such propeller 1102 resembles a duck bill and extends either fore or aft of the aircraft depending on its mounted location. When so folded, the corresponding motor may be shut off as no thrust is possible. In some embodiments, the aircraft 10 may rely primarily on one set of propellers during ascent and descent when air is dense and then fold those propellers and rely on the other ones for thrust when operating at higher altitudes. The configuration according to this embodiment allows the aircraft to achieve more efficient use of power by relying on propellers that are optimized in their performance characteristics for given altitudes (dense or thin air), extending the aircraft's range and endurance. This multiple, folding propeller arrangement is less costly and lighter weight than complex adjustable pitch propellers normally used to achieve desired performance gains.

Whether the aircraft is arranged in a pusher or tractor configuration or a combination, electronic speed controllers with regenerative braking and reversal functions can be applied to the electric motors. Beneficially, the aircraft will be able to approach a landing site with an unusually steep glide slope and upon touch down, full rearward thrust can be applied with all motors and propellers. In some aspects, braking can also be applied with electric wheel drive motors if the aircraft is so equipped. This will dramatically shorten landing distance requirements and allow the aircraft to dive over high obstacles into tight locations on landing approach.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention. The subject matter described herein and in the recited claim intends to cover and embrace all suitable changes in technology.

1. A weight-shift aerial vehicle comprising:
a frame;
a wing assembly defining a flexible sail extending from port to starboard sides of the vehicle, the flexible wing assembly comprising:
a wing keel extending from fore to aft ends of the wing assembly;
a pair of wings, wherein each side of said pair of wings has a strut coupled to and extending away from the wing keel and defines a leading edge and a trailing edge when the wing assembly is moved though air, wherein the trailing edge of each side of said pair of wings is configured for actuable reversible billowing in at least a portion along a length of the trailing edge, wherein the actuable reversible billowing in at least a portion along a length of the trialing edge of a first side of said pair of wings is effected by actuable movement that brings the wing keel a distance towards an intersection of the leading edge with the strut of the first side of said pair of wings, brings the at least a portion along a length of the trailing edge a distance towards an intersection of the leading edge with the strut of the first side of said pair of wings, or that brings the at least a portion along a length of the trailing edge a distance towards an intersection of the leading edge with the strut of the first side of said pair of wings;
a joint pivotally coupling the frame to the wing assembly, the joint configured to permit the frame to rotate in at most two mutually orthogonal axes of rotation relative to the wing assembly, wherein pivotal movement of the frame relative to the wing assembly shifts the center of mass of the frame beneath the wing assembly; and
a propulsion unit for providing thrust coupled to the frame, the wing assembly, or both the frame and the wing assembly.

2. (canceled)

3. (canceled)

4. (canceled)

5. The aerial vehicle of claim 1 wherein actuation of the actuable reversible billowing on one side of said pair of wings is independent from or is simultaneous with actuation of the actuable reversible billowing in the other side of said pair of wings.

6. The aerial vehicle of claim 1 wherein said trailing edge extends aft of an intersection of the wing keel and the trailing edge.

7. The aerial vehicle of claim 1 wherein the frame comprises a downwardly extending mast that pivotally couples the frame to the joint and a support coupled to and extending away from the mast.

8. The aerial vehicle of claim 7 wherein the support is adapted to carry the propulsion unit, cargo and/or sensor equipment ahead of the mast.

9. The aerial vehicle of claim 8 wherein the cargo and/or sensor equipment is moveably supported such that displacement of the cargo and/or sensor equipment permit fine tuning of the overall balance and center of mass of the aerial vehicle.

10. The aerial vehicle of claim 1 wherein the propulsion unit comprises one or more propellers.

11. The aerial vehicle of claim 10 wherein the propulsion unit comprises a pair of propellers arranged in side-by-side arrangement or the propulsion unit comprises a pair of propellers arranged along a common longitudinal axis.

12. (canceled)

13. The aerial vehicle of claim 11 wherein the pair of propellers is configured so that one of the pair of propellers has one or more of contrasting aerodynamic and performance optimization and operation at different speeds of rotation relative to the other of the pair of propellers.

14. The aerial vehicle of claim 10 wherein the one or more propellers comprise blades moveable between an extended working position and a retracted rest position or wherein the one or more propellers are emplaced forward of the wing.

15. (canceled)

16. The aerial vehicle of claim 10 further comprising a shroud to cover the one or more propellers to prevent unintentional contact.

17. The aerial vehicle of claim 1 further comprising a petrol motor for driving the propulsion unit; an electric motor for driving the propulsion unit: a battery for powering an electric motor for driving the propulsion unit and a generator for powering the battery: a battery for powering an electric motor for driving the propulsion unit, a generator for powering the battery, and a fuel tank for powering the generator: or an electric motor for driving the propulsion unit and a generator for powering the electric motor.

18. (canceled)

19. The aerial vehicle of claim 1 further comprising a landing gear assembly extending downwards from the wing keel, the landing gear assembly comprising a pair of down tubes connected to each other at one end and a control bar having ends for connecting another end of each one of the pair of down tubes, and a pair of wheel for rolling on terrain or a pair of floats or skis.

20. The aerial vehicle of claim 19 wherein the pair of wheels are powered for assisting takeoff and/or for providing maneuverability on the ground.

21. The aerial vehicle of claim 1 wherein the flexible wing assembly further comprises vertical winglets at the port and starboard ends.

22. The aerial vehicle of claim 1 wherein the two mutually orthogonal axes of rotation is a first horizontal axis for permitting roll of the frame relative to the wing and a second horizontal axis orthogonal to the first axis for adjusting pitch of the frame relative to the wing assembly.

23. A method for recovering or preventing a spiral dive or a stall of a weight-shift aerial vehicle during flight, the vehicle having a frame; a wing assembly defining a flexible sail that extends from port to starboard sides of the vehicle; the flexible wing assembly comprising: a wing keel extending from fore to aft ends of the wing assembly; a pair of wings, wherein each side of said pair of wings has a strut coupled to and extending away from the wing keel and defines a leading edge and a trailing edge when the wing assembly is moved though air; wherein the trailing edge of each side of said pair of wings is configured for actuable reversible billowing in at least a portion along a length of the trailing edge; a joint permitting for pivotal movement of the frame relative to the wing assembly to shift the center of mass of the frame beneath the wing assembly; and a propulsion unit for providing thrust coupled to the frame, the wing assembly, or both the frame and the wing assembly, the method comprising the steps of:
identifying a pre-condition leading to a stall or a spiral dive during flight; and
altering the shape of the flexible sail by reversibly actuating billowing in at least a portion along a length of the trialing edge in one side of said pair of wings or both sides of said pair of wings, wherein the reversibly actuating billowing comprises: decreasing a distance between the wing keel and an intersection of the leading edge with the strut of a first side of said pair of wings: decreasing a distance between at least a portion along a length of the trialing edge and an intersection of the leading edge with the strut of a first side of said pair of wings; decreasing a distance between the wing keel and at least a portion along a length of the trailing edge while leaving unaltered the distance between the wing keel and an intersection of the leading edge with the strut of a first side of said pair of wings: or a combination thereof; and thereby recovering or preventing the spiral dive or the stall of the weight-shift aerial vehicle.

24. (canceled)

25. The method of claim 2 wherein the reversibly actuating billowing on one side of said pair or wings is independent of or is simultaneous with an actuation of the actuable reversible billowing in the other side of said pair of wings.

26. The method of claim 23 wherein the pre-condition leading to a stall or a spiral dive during flight comprises one or more of air speed, roll, angle of attack, absolute position of the wing assembly with respect to the earth and the relative position of the fuselage with respect to the wing assembly.

27. The method of claim 23 wherein the pre-condition leading to a stall or a spiral dive during flight comprises low airspeeds, high angle of attack, and/or when lift on one side is lost if the wing is rolled too far to one side.
